(19) United States
(12) Patent Application Publication
(10) Pub. No.: US 2025/0317903 A1
(43) Pub. Date: Oct. 9, 2025

(54) TIME DIVISION DUPLEXING (TDD) UPLINK COVERAGE EXTENSION USING FREQUENCY DIVISION DUPLEXING (FDD)

(71) Applicant: AT&T Intellectual Property I, L.P., Atlanta, GA (US)

(72) Inventors: ERNEST TSUI, Danville, CA (US); Jianchun Zhou, Bellevue, WA (US); Weihua Ye, Chicago, IL (US)

(73) Assignee: AT&T Intellectual Property I, L.P., Atlanta, GA (US)

(21) Appl. No.: 18/625,944

(22) Filed: Apr. 3, 2024

(51) Int. Cl. H04W 72/02; H04B 17/318; H04L 5/14; H04W 52/36; H04W 72/0453

(52) U.S. Cl. CPC H04W 72/02; H04B 17/328; H04L 5/1469; H04W 52/365; H04W 72/0453

(57) ABSTRACT

Aspects of the subject disclosure may include, for example, determining a quality of a communication path between a user equipment (UE) and a base station, resulting in a determined quality, and based on the determined quality, controlling aggregation of one or more time division duplexing (TDD) carriers and one or more frequency division duplexing (FDD) carriers in an uplink (UL) such that either the one or more TDD carriers or the one or more FDD carriers are selected for a Primary cell (Pcell) for the UE. Other embodiments are disclosed.

### FIELD OF THE DISCLOSURE

The subject disclosure relates to time division duplexing (TDD) extension using frequency division duplexing (FDD).

### BACKGROUND

The uplink (UL) of a wireless network is becoming increasingly important for certain applications, particularly those that require large amounts of data. These include broadcast video applications, real-time video applications, and the like.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIGS. 2B and 2C show measurements obtained over time during a drive test from near cell to far cell.

FIG. 2D depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The UL is fundamentally limited by user equipment (UE) power and battery life, particularly at the cell edge where throughput may be severely reduced. The problem of limited UE transmit power is difficult to overcome considering that the size and weight of a given UE is highly constrained and battery improvements advance far slower than advances in semiconductor technology. Since downlink (DL) coverage generally rests on a reliable UL, limited UL coverage can hamper the overall achievable coverage of existing and future wireless networks. Indeed, in a TDD system, the limited power of, and thus limited UL coverage for, a given UE limits the TDD DL coverage, despite the base station having sufficient power for the TDD DL. Generally speaking, the TDD DL covers more ground than the TDD UL. For instance, about 80% of a TDD time slot is allotted to the TDD DL, leaving only about 20% thereof for the TDD UL. Given a UE's peak power limitation, it is incapable of transmitting about 4× the power/energy to compensate for this imbalance, and thus there is at least a 6 decibel (dB) deficiency in the TDD UL. Furthermore, the imbalance in coverage may also arguably be due to more powerful TDD DL transmission capabilities at the base station relative to the transmission capabilities of the UE. In contrast to TDD, an FDD DL and UL are provided the same amount of time for transmissions, and thus the FDD UL does not suffer any such deficiency. Furthermore, FDD carriers are typically in a lower frequency band (thus providing for better penetration), which makes them more efficient especially at the boundaries of cell coverage.

The subject disclosure describes, among other things, illustrative embodiments of a carrier aggregation control system (or platform) that employs FDD to extend the coverage of a TDD UL by controlling aggregation of TDD and FDD carriers. In exemplary embodiments, the carrier aggregation control system may join a TDD carrier (typically a mid- or high-band carrier that is at a high enough frequency to make propagation indoors and diffraction over buildings difficult) together with an FDD carrier that is at a lower frequency, such that the TDD UL carrier can be used for the primary cell (Pcell) (also referred to in short as T+F aggregation). In various embodiments, a massive multiple-input-multiple-output (MIMO) antenna (with programmable massive MIMO techniques) may be used for the FDD carrier to provide for a significantly larger antenna gain, which can compensate for the limited UE transmit power. This can result in an FDD UL carrier that is much stronger than the TDD UL carrier. In a case where the TDD leg data buffer begins to overflow at the UE due to diminishing TDD UL coverage (such as may occur if the UE is at or near the cell edge), the UL and the UE transmit power may be shifted/diverted from the TDD leg to the FDD leg, where the FDD UL carrier is used for the Pcell (also referred to in short as F+T aggregation). Here, a scheduler may divert some or all of the data that is unable to pass through the TDD UL, to now instead be sent via the FDD UL carrier. The TDD UL may either be disabled or controlled to carry minimal to no UL data, which avoids the UE from unnecessarily driving the TDD UL at full transmit power, thereby conserving UE power resources. Keeping the TDD UL enabled at the cell edge if even for just some signaling (e.g., demodulation reference signals (DMRS)) can be useful particularly in non-collated environments, where the TDD UL can at least be used by the UE for a neighbor site that the UE may now be closer to. In sum, the FDD leg can sustain the UL even while the TDD DL is still working or active, resulting in a TDD “down” and FDD “up” situation where good TDD downlink coverage is sustained along with reasonable UL throughput via FDD. Of course, the FDD DL may also be maintained at the cell edge, where most (if not all) of the UL signaling may be transmitted via the FDD UL.

Providing for TDD UL coverage extension using FDD massive MIMO, as described herein, provides for improved UL coverage into the cell edge, where subscribers are more likely to churn (e.g., change operators, etc.). Additionally, TDD DL throughput benefits are maintained where they may otherwise be lost. Indeed, matching the UL coverage to the DL coverage (where, typically, there may be tens of dB of imbalance) allows a network operator to take advantage of the large bandwidths available with TDD for more throughout. With the FDD UL carrier utilizing the full slot for power/energy transmission coupled with the lower frequency of the FDD carrier and larger antenna gain at the base station, the above-described UL coverage deficiency can essentially be equalized. Further, utilizing massive MIMO for both TDD and FDD supports the TDD carrier as well as the FDD carrier in terms of expanded coverage, all at a suitable investment to return ratio. Aggregating TDD (UL limited) carriers with one or more FDD carriers using massive MIMO also improves not only the UL but also the DL of future Stand-Alone (SA) 5G networks (and beyond) as well.

One or more aspects of the subject disclosure include a device, comprising a processing system including a processor, and a memory that stores executable instructions that, when executed by the processing system, facilitate performance of operations. The operations can include determining a quality of a communication path between a user equipment (UE) and a base station, resulting in a determined quality. Further, the operations can include, based on the determined quality, controlling aggregation of one or more time division duplexing (TDD) carriers and one or more frequency division duplexing (FDD) carriers in an uplink (UL) such that either the one or more TDD carriers or the one or more FDD carriers are selected for a Primary cell (Pcell) for the UE.

One or more aspects of the subject disclosure include a non-transitory machine-readable medium, comprising executable instructions that, when executed by a processing system including a processor, facilitate performance of operations. The operations can include analyzing conditions associated with communications between a user equipment (UE) and a base station. Further, the operations can include, based on the analyzing, causing one or more time division duplexing (TDD) uplink (UL) carriers or one or more frequency division duplexing (FDD) UL carriers to be selected for a Primary cell (Pcell) for the UE.

One or more aspects of the subject disclosure include a method. The method can comprise sending, by a processing system of a user equipment (UE) including a processor, one or more measurements associated with communications between the UE and a base station. Further, the method can include, after the sending, receiving, by the processing system and from the base station, a command to use a selected carrier in an uplink (UL) for a Primary cell (Pcell), wherein the selected carrier comprises a time division duplexing (TDD) carrier or a frequency division duplexing (FDD) carrier. Further, the method can include, based on the command, causing, by the processing system, all or more than a threshold portion of transmit power resources to be utilized for the selected carrier.

Other embodiments are described in the subject disclosure.

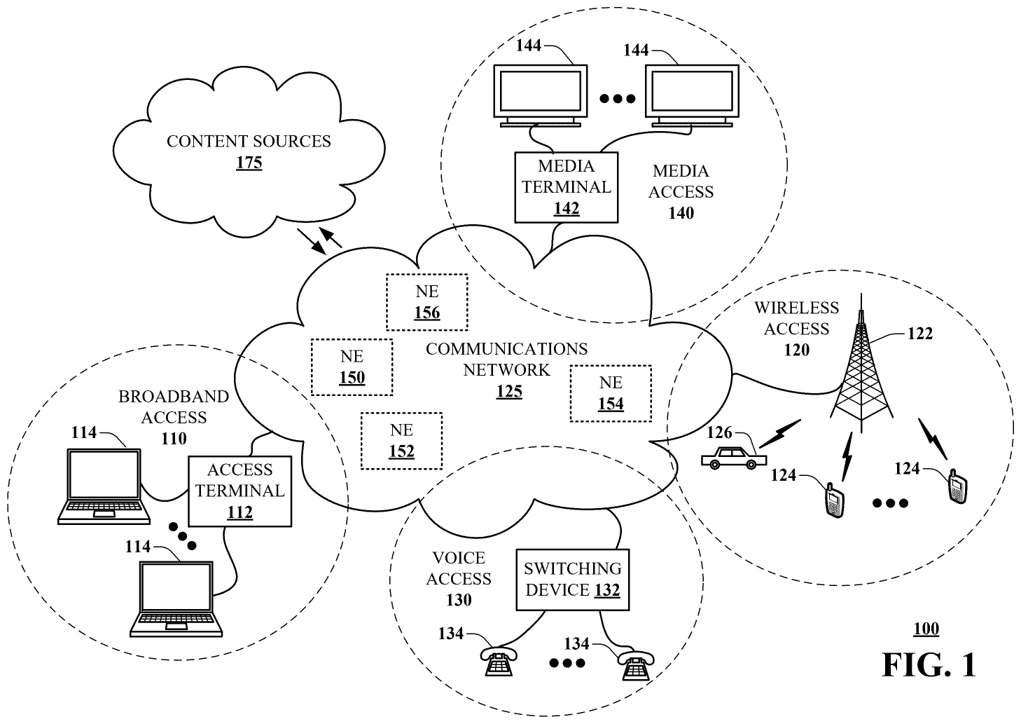

Referring now to FIG. 1, a block diagram is shown illustrating an example, non-limiting embodiment of a system 100 in accordance with various aspects described herein. For example, system 100 can facilitate, in whole or in part, controlling of carrier aggregation for a UE such that TDD carrier(s) or FDD carrier(s) are selected as the dominant carrier(s) in the UL based on conditions relating to communications between the UE and a base station. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

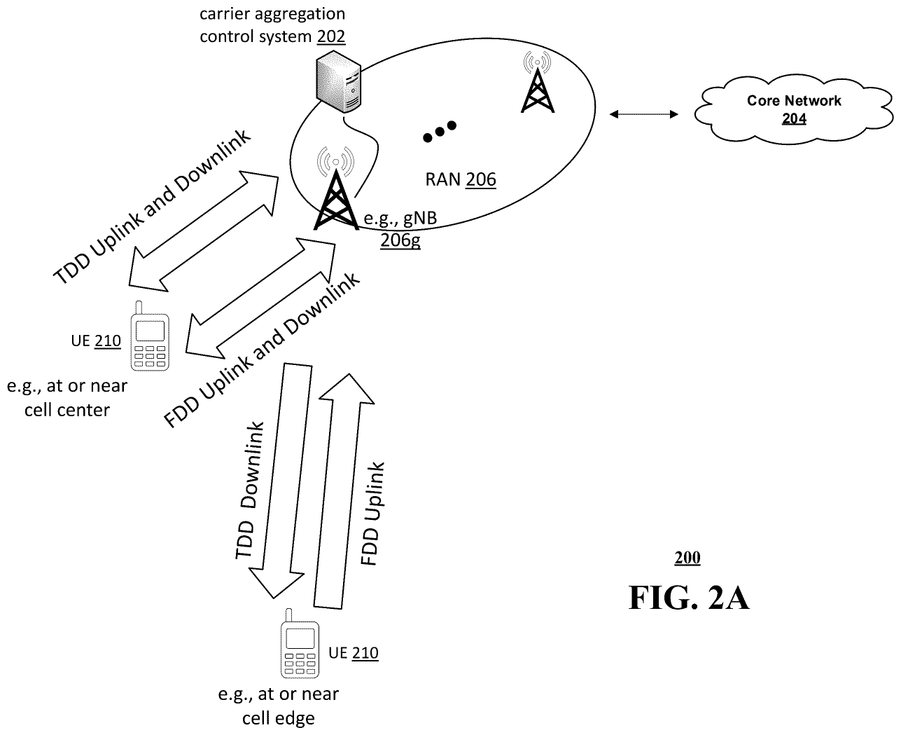

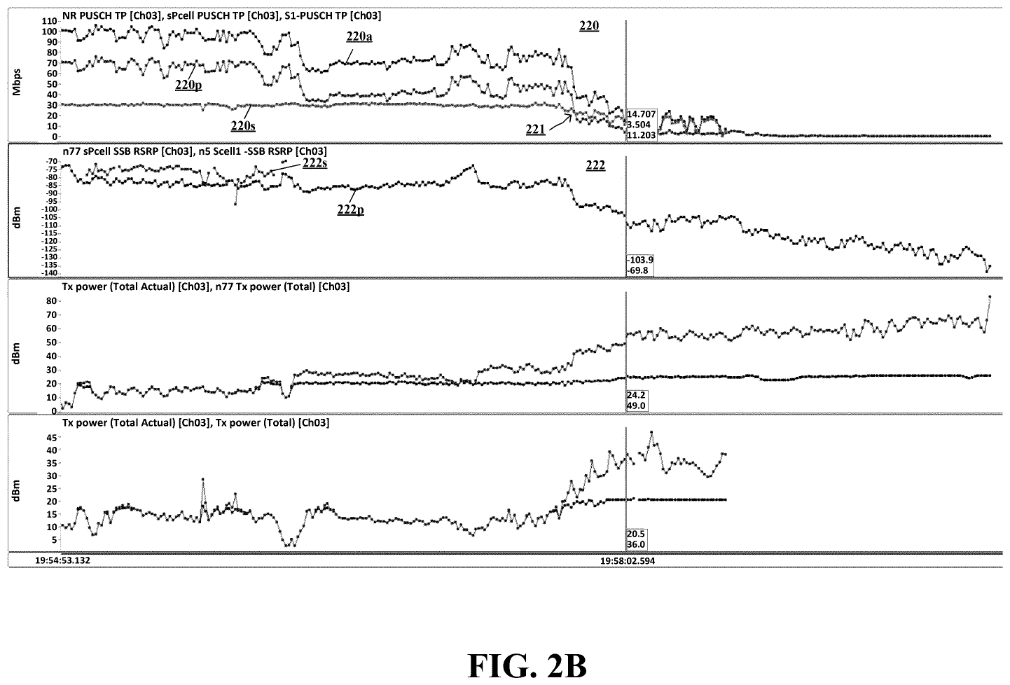

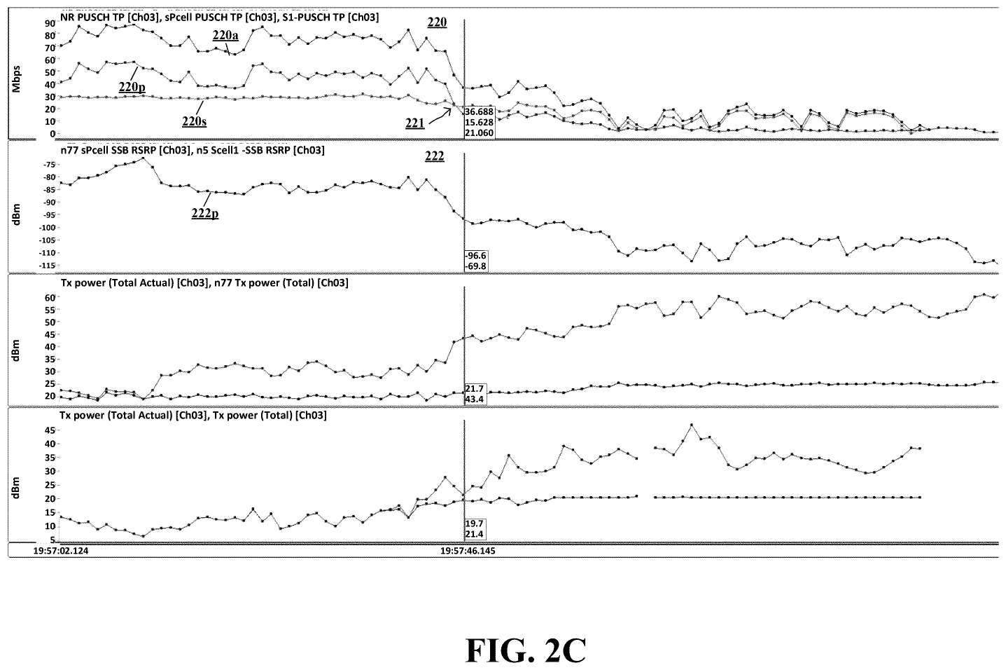

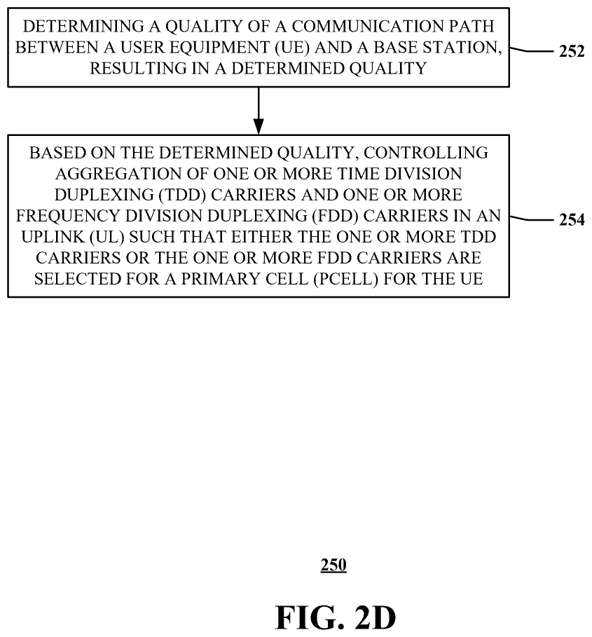

FIG. 2A is a block diagram illustrating an example, non-limiting embodiment of a system 200 functioning within, or operatively overlaid upon, the communications network 100 of FIG. 1 in accordance with various aspects described herein. As shown in FIG. 2A, the system may include a carrier aggregation control system 202, a core network 204, a radio access network (RAN) 206, and one or more UEs 210.

The core network 204 may include network devices and/or systems that provide a variety of functions. In certain embodiments, the core network 204 may be implemented in a cloud architecture. Examples of functions provided by, or included, in the core network 204 include an access mobility function (AMF) configured to facilitate mobility management in a control plane of the network system (including, for instance, providing UE mobility information associated with the RAN 206 and/or UEs 210 to the core network 204), a user plane function (UPF) configured to provide access to a data network, such as a packet data network (PDN), in a user (or data) plane of the network system, a Unified Data Management (UDM) function, a Session Management Function (SMF), a policy control function (PCF), and/or the like. The core network 204 may be in communication with one or more other networks (e.g., one or more content delivery networks (CDNs)), one or more services, cloud server(s), and/or one or more other devices. In one or more embodiments, the core network 204 may include one or more devices implementing other functions, such as a master user database server device for network access management, a PDN gateway server device for facilitating access to a PDN, and/or the like. The core network 204 may include various physical/virtual resources, including server devices, virtual environments, databases, and so on.

In various embodiments, the RAN 206 may include a wireless RAN, a Wi-Fi network, and/or a wireline network. In one or more embodiments, the RAN 206 may be implemented in open source software (e.g., in an OpenAirInterface (OAI) wireless technology platform). The RAN 206 may include network resources, such as one or more physical access resources and/or one or more virtual access resources. Physical access resources can include base station(s) (e.g., one or more gNodeBs (gNBs), one or more eNodeBs (eNBs), or the like), one or more satellites, one or more Gigabyte Passive Optical Networks (GPONs) or related components (e.g., Optical Line Terminal(s) (OLT), Optical Network Unit(s) (ONU), etc.), and/or the like. A base station may employ any suitable radio access technology (RAT), such as 4G/LTE, 5G, 6G, or any higher generation RAT. One or more edge computing devices (e.g., multi-access edge computing (MEC) devices or the like) may also be included in or associated with the RAN 206. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the RAN 206 may include any number/types of physical/virtual access resources and various types of heterogeneous cell configurations with various quantities of cells and/or types of cells. In certain embodiments, the RAN 206 may be implemented as a virtual RAN, where radio/wireline functions are implemented as general-purpose applications/apps that operate in virtualized environments and interact with physical resources either directly or via full/partial hardware emulation. Virtualized software radio applications can be delivered as a service and managed through a cloud controller. Here, base stations may be implemented as (e.g., passive) distributed radio elements connected to a centralized baseband processing pool. In some embodiments, the RAN 206 may include, or communicate with, a RAN intelligent controller (RIC).

A UE 210 may be any computing device that is capable of obtaining and/or processing data and communicating information with one or more other devices (e.g., over networks 204, 206). As some non-limiting examples, a UE 210 may be a communication device (e.g., a router, a modem, a mobile phone, or a wearable device, such as a smart wristwatch, a pair of smart eyeglasses, media-related gear (e.g., augmented reality (AR), virtual reality (VR), or mixed reality (MR) glasses and/or headset/headphones)), a biometric sensor (e.g., for monitoring heart rate, blood pressure, pulse, breathing, etc.), an electrical switch controller, a security camera, an automated assistant, a smart TV, an environmental sensor/controller (e.g., for lighting, temperature, audio, etc.), a kitchen/bath appliance controller (e.g., for a stove, a dehumidifier, etc.), a drapery (e.g., curtain, shade, blinds, or the like) controller, a door/lock controller (e.g., for a room door, a garage door, etc.), a tracking device (e.g., for tracking objects on the road, in a factory/warehouse setting, etc.), a vehicle, a similar type of device, a different type of device, or a combination of some or all of these devices.

As shown in FIG. 2A, a gNB 206g in the RAN 206 may provide cell coverage to UEs 210. In exemplary embodiments, the gNB 206g may be configured to communicate with UEs 210 using TDD and FDD. In one or more embodiments, the gNB 206b may be equipped with respective massive MIMO systems for TDD and FDD. A massive MIMO system may comprise, for instance, aggregated or combined modular adaptive/active/advanced antenna systems (AAS) or arrays, such as that described in U.S. patent application Ser. No. 17/376,767 filed on Jul. 15, 2021 (now issued as U.S. Pat. No. 11,611,456), which is incorporated by reference herein in its entirety.

The carrier aggregation control system 202 may be configured to control aggregation of carriers for different UEs 210. Carrier aggregation involves the simultaneous use of multiple carriers to form a larger channel for data communications. The combination of component carriers sums their data rates, which increases data throughput and reduces latency, thereby providing a more efficient network. While examples discussed herein generally focus on the aggregation of a single TDD carrier and a single FDD carrier, it will be understood and appreciated that one or more TDD carriers may be aggregated with one or more FDD carriers.

In exemplary embodiments, the carrier aggregation control system 202 may be configured to determine a quality of a communication path between a UE 210 and a base station (e.g., gNB 206g), and control aggregation of a TDD carrier and an FDD carrier such that either the TDD carrier or the FDD carrier is selected for a Pcell for the UE 210 depending on the determined quality. Controlling aggregation may involve configuration at the base station as well as signaling between the base station and the UE 210 to control how the UE 210 allocates transmit power and transmit data between the component carriers. As the quality of the communication path between a UE 210 and a gNB 206g may vary based on the location of the UE 210 in the cell, leveraging a particular type of carrier as the dominant carrier depending on the circumstance can improve coverage for the UE 210. For instance, at or near the cell edge, the TDD UL throughput may suffer due to the large distance from the gNB 206b and limited UE transmit power, whereas, at or near the cell center, the TDD UL throughput may be superior and reliable.

In exemplary embodiments, the carrier aggregation control system 202 may determine to use a TDD UL carrier for the Pcell (e.g., SA 5G) and an FDD UL carrier as a secondary cell (Scell or sPcell) for a UE 210 when conditions relating to communications between the gNB 206g and the UE 210 indicate that the UE 210 is likely located at or near the center of the cell (e.g. within a threshold distance from the gNB 206g). Dominant use of the TDD UL carrier here allows for the use of sounding reference signals (SRS) from the UE 210, which enables better channel estimation and thus better performance. In various embodiments, the carrier aggregation control system 202 may determine to use an FDD UL carrier for the Pcell and a TDD UL carrier as the SCell for a UE 210 when conditions relating to communications between the gNB 206g and the UE 210 indicate that the UE 210 is likely located at or near an edge of the cell (e.g., greater than a threshold distance from the gNB 206g). With a diminished TDD UL, the UE 210 may of course not be able to transmit reliable SRS, and thus the gNB 206g may need to rely on codebooks and channel quantization for channel estimation. However, the lower frequency of the FDD UL carrier allows for better penetration than the TDD UL carrier, and thus substantially better UL coverage at or near the cell edge. Use of an AAS antenna panel for FDD also provides for improved antenna gain, which can compensate for the limited UE transmit power.

Reference signal received power (RSRP) measures the received power level of reference signals that are transmitted from the base station to a UE, which measurements may be provided by the UE to the base station. In one or more embodiments, the carrier aggregation control system 202 may determine whether to use a TDD UL carrier or an FDD UL carrier for the Pcell based on the TDD DL RSRP and/or the FDD DL RSRP. For instance, in some embodiments, the carrier aggregation control system 202 may determine to use a TDD UL carrier for the Pcell if the TDD DL RSRP is greater than or equal to (>=) a threshold RSRP. As another example, in some embodiments, the carrier aggregation control system 202 may determine to use an FDD UL carrier for the Pcell if the FDD DL RSRP is greater than or equal to (>=) a threshold RSRP.

Reference signal received quality (RSRQ) measures the quality of the reference signals that are transmitted from the base station to the UE, relative to interference and noise. Signal-to-interference-plus-noise ratio (SINR) measures the ratio of the desired signal power to the combined interference and noise power. SINR may be equal to normalized RSRQ, but without the load affecting the RSRQ. These measurement(s) are typically provided by the UE to the base station. Dense urban cells generally introduce a lot of interference. In such cells, it might not be reliable to determine whether to use the TDD UL carrier for the Pcell simply based on the TDD DL RSRP since the TDD DL RSRP might not inform on or equate to TDD UL carrier SINR. Similarly, it might not be reliable to determine whether to use the FDD UL carrier for the Pcell simply based on the FDD DL RSRP since the FDD DL RSRP might not inform on or equate to FDD UL carrier SINR.

In exemplary embodiments, the carrier aggregation control system 202 may (e.g., in the case of a dense urban cell, such as one that has a density that exceeds a predefined density) determine whether to use a TDD UL carrier or an FDD UL carrier for the Pcell based the TDD DL RSRP, the TDD DL RSRQ/SINR, the FDD DL RSRP, and/or the FDD DL RSRQ/SINR. For instance, in a case where the carrier aggregation control system 202 determines that the TDD DL RSRP is greater than or equal to (>=) a threshold RSRP, the carrier aggregation control system 202 may determine to use a TDD UL carrier for the Pcell if (e.g., only if) the TDD RSRQ/SINR is greater than or equal to (>=) a threshold RSRQ/SINR. As another example, in a case where the carrier aggregation control system 202 determines that the FDD DL RSRP is greater than or equal to (>=) a threshold RSRP, the carrier aggregation control system 202 may determine to use an FDD UL carrier for the Pcell if (e.g., only if) the FDD RSRQ/SINR is greater than or equal to (>=) a threshold RSRQ/SINR. In this way, the carrier aggregation control system 202 can leverage DL RSRQ/SINR to ensure that the appropriate TDD or FDD UL carrier is used by the UE in a dense urban cell.

In certain embodiments, the carrier aggregation control system 202 may additionally, or alternatively, consider UL SINR. As an example, the carrier aggregation control system 202 may determine to use a TDD UL carrier for the Pcell if (e.g., only if) the TDD UL SINR is greater than or equal to (>=) a threshold SINR. As another example, the carrier aggregation control system 202 may determine to use an FDD UL carrier for the Pcell if (e.g., only if) the FDD UL SINR is greater than or equal to (>=) a threshold SINR. In some embodiments, the Uplink In-Band Loopback Error Rate (UL iBLER) may be used as a proxy for UL SINR. For instance, the error rate measurement obtained for the TDD UL carrier band may be used as an estimate of TDD UL SINR and/or the error rate measurement obtained for the FDD UL carrier band may be used as an estimate of FDD UL SINR.

In various embodiments, the carrier aggregation control system 202 may determine whether to use a TDD UL carrier or an FDD UL carrier for the Pcell based on path losses associated with the TDD UL carrier and the FDD UL carrier. In one or more embodiments, the carrier aggregation control system 202 may measure path losses based on the TDD DL carrier RSRP and the FDD DL carrier RSRP. For instance, the carrier aggregation control system 202 may determine to use an FDD UL carrier for the Pcell if the TDD DL RSRP is less than (<) a threshold or is less than (<) the FDD DL carrier RSRP by more than a threshold amount (e.g., by more than 20 dBm, 30 dBm, 40 dBM, etc.). The threshold or threshold amount may correspond to a point or situation where the FFD UL carrier throughput constitutes a substantial portion of (e.g., more than a threshold portion of) the total carrier aggregation throughput, which may warrant use of the FDD UL carrier for the Pcell. Addressing the path loss dictated cell edge in this manner advantageously extends UL coverage and conserves UE transmit power. As another example, the carrier aggregation control system 202 may determine to use a TDD UL carrier for the Pcell if the TDD DL RSRP is not less than (not <) a threshold or is not less than (not <) the FDD DL carrier RSRP by more than a threshold amount (e.g., not less than the FDD DL carrier RSRP by more than 20 dBm, 30 dBm, 40 dBM, etc.). The threshold or threshold amount may correspond to a point or situation where the FFD UL carrier throughput does not constitute a substantial portion of (e.g., not more than a threshold portion of) the total carrier aggregation throughput, which may warrant use of the TDD UL carrier for the Pcell, thus enabling for SRS mode.

In some embodiments, the carrier aggregation control system 202 may not consider using a TDD UL carrier for the Pcell unless the TDD UL carrier SINR satisfies (e.g., is greater than or equal to) a threshold or unless SINR that may be inferred from the TDD DL carrier RSRP (TDD DL path loss) satisfies (e.g., is greater than or equal to) a threshold. Similarly, the carrier aggregation control system 202 may not consider using an FDD UL carrier for the Pcell unless the FDD UL carrier SINR satisfies (e.g., is greater than or equal to) a threshold or unless SINR that may be inferred from the FDD DL carrier RSRP (FDD DL path loss) satisfies (e.g., is greater than or equal to) a threshold.

FIGS. 2B and 2C show measurements obtained over time during a drive test from near cell to far cell. At portion 220 of FIGS. 2B and 2C are depicted the total aggregate throughput 220a, the throughput 220p for a TDD UL carrier used for the Pcell, and the throughput 220s for an FDD UL carrier used for the SCell. At portion 222 of FIGS. 2B and 2C are depicted the RSRP 222p for a TDD DL carrier and the RSRP 222s for an FDD DL carrier. As depicted, the throughput 220p for the TDD UL carrier and the RSRP 222p for the TDD DL carrier decrease as the UE moves farther away from the cell center over time. In fact, the throughput 220p for the TDD UL carrier eventually crosses below the throughput 220s for the FDD UL carrier-see reference number 221, more clearly shown in FIG. 2B. On the other hand, the RSRP 222s for the FDD DL carrier remains high (high enough that it is beyond what is displayed on the graph) as the UE moves farther away from the cell center. This difference in RSRP between the TDD DL carrier and the FDD DL carrier (a difference of more than 30 dBm) indicates that the FDD UL carrier has much better path loss (i.e., much less loss due to interference, etc.) than the TDD DL carrier. This correlates with higher throughput 220s for the FDD UL carrier relative to the throughput 220p for the TDD UL carrier that continues after the crossover at 221. One skilled in the art would readily recognize the benefits of applying the embodiments of carrier aggregation control described above to address the diminishing TDD UL coverage in such a scenario. By monitoring the relative RSRPs, the relative throughputs, the relative UL SINRs between TDD and FDD, more (or all resources) can be diverted from one UL carrier to the other, depending on the circumstances. This advantageously extends UL coverage for the UE, which allows the TDD DL to be used even at or near the cell edge, and reduces or avoids unnecessary UE transmit power allocations for the TDD UL carrier when unwarranted.

Where the carrier aggregation control system 202 determines to use the FDD carrier UL for the Pcell (e.g., such as in a case where the UE is at or near the cell edge), the carrier aggregation control system 202 may or may not split utilization across the FDD and TDD carriers. As an example, the carrier aggregation control system 202 may cause data to be transmitted using only the FDD UL carrier (i.e., 100% allocation, while maintaining the TDD UL carrier in aggregation). In this example, the UE may only utilize transmit power for the FDD UL carrier. As another example, the carrier aggregation control system 202 may cause the FDD UL carrier to be the dominant, but not sole, carrier for UL transmission (i.e., allocating more than a threshold portion (e.g., 80%, 90%, etc.) of the aggregation to the FDD UL). In this example, the UE may utilize a corresponding portion of its transmit power for the FDD UL carrier and the remaining transmit power for the TDD UL carrier. It will be understood and appreciated that allocating more (or even all) of the aggregation to the FDD UL carrier when the UE is at or near the cell edge provides for more efficient performance.

Similarly, where the carrier aggregation control system 202 determines to use the TDD carrier UL for the Pcell (e.g., such as in a case where the UE is at or near the cell center), the carrier aggregation control system 202 may or may not split utilization across the TDD and FDD carriers. As an example, the carrier aggregation control system 202 may cause data to be transmitted using only the TDD UL carrier (i.e., 100% allocation, while maintaining the FDD UL carrier in aggregation). In this example, the UE may only utilize transmit power for the TDD UL carrier. As another example, the carrier aggregation control system 202 may cause the TDD UL carrier to be the dominant, but not sole, carrier for UL transmission (i.e., allocating more than a threshold portion (e.g., 80%, 90%, etc.) of the aggregation to the TDD UL). In this example, the UE may utilize a corresponding portion of its transmit power for the TDD UL carrier and the remaining transmit power for the FDD UL carrier. It will be understood and appreciated that allocating more (or even all) of the aggregation to the TDD UL carrier when the UE is at or near the cell center provides for more efficient performance.

In exemplary embodiments, the carrier aggregation control system 202 may, even in a case where most or all of the data are to be diverted to the TDD UL carrier or to the FDD UL carrier, nevertheless keep the other UL carrier active or ready for use. That is, the carrier aggregation control system 202 may or may not fully disable or turn off the other UL carrier despite commanding the UE to divert its power resources for the TDD UL carrier or for the FDD UL carrier. This allows the other UL carrier to remain aggregated (albeit on standby) and be quickly or immediately usable again should path conditions and/or signal quality change. For instance, assume that a UE 210 is at or near the cell center and that a TDD UL carrier is used for the Pcell for a UE 210, where an equal amount (50%), most (>50%+), or all (100%) of the data is transmitted using the TDD UL carrier relative to an FDD UL carrier and/or where an equal amount (50%), most (>50%+), or all (100%) of the UE 210's transmit power resources are dedicated or allocated for the TDD UL relative to the FDD UL. In this example, if the UE 210 moves away from the cell center and the channel quality drops as a result, the carrier aggregation control system 202 may select the FDD UL carrier for the PCell, and may command the UE 210 to transmit most (>50%+) or all (100%) of the UL data using the FDD UL carrier and/or to dedicate most (>50%+) or all (100%) of the UE 210's transmit power for the FDD UL carrier. Should the carrier aggregation control system 202 determine a later change in channel conditions (e.g., based on any of the example criteria described herein, such as those relating to RSRP, RSRQ/SINR, etc.) that warrants a switchback to the TDD UL carrier, the carrier aggregation control system 202 may select the TDD UL carrier for the PCell, and may command the UE 210 to transmit most (>50%+) or all (100%) of the UL data using the TDD UL carrier and/or to dedicate most (>50%+) or all (100%) of the UE 210's transmit power for the TDD UL carrier. In this way, the carrier aggregation control system 202 may dynamically control carrier aggregation based on the quality of the communication path (or conditions associated with communications) between the base station and a given UE 210.

In various embodiments, switching from using TDD carrier(s) for the Pcell to using FDD carrier(s) for the Pcell may be performed based on UL transmit power headroom (i.e., margin between UL transmit power and a maximum transmit power limit) and physical resource block (PRB) scheduling. From UL transmit power headroom data samples, it can be determined whether the UL transmit power satisfies a condition—i.e., equals or exceeds the maximum transmit power limit for longer than a threshold period (e.g., 1 second, 2 seconds, 3 seconds, etc.) or has reached or exceeded the maximum transmit power limit more than threshold number of times (e.g., 2 times, 3 times, etc.) during the threshold period. As a function of scheduled PRBs (where fewer PRBs are scheduled as the UE moves closer to the cell edge, ultimately reaching a minimum number of PRBs), carrier aggregation can be controlled to switch from using TDD carrier(s) for the Pcell to using FDD carrier(s) for the Pcell in a case where the minimum number of PRBs has been reached and the aforementioned UL transmit power-related condition is satisfied.

It is to be understood and appreciated that, although one or more of FIGS. 1 and 2A-2C might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, networks, modules, circuits, etc. may have been illustrated in one or more of FIGS. 1 and 2A as separate components, devices, systems, networks, modules, circuits, etc., it will be appreciated that multiple components, devices, systems, networks, modules, circuits, etc. can be implemented as a single component, device, system, network, module, circuit, etc., or a single component, device, system, network, module, circuit, etc. can be implemented as multiple components, devices, systems, networks, modules, circuits, etc. Additionally, functions described as being performed by one component, device, system, network, module, circuit, etc. may be performed by multiple components, devices, systems, networks, modules, circuits, etc., or functions described as being performed by multiple components, devices, systems, networks, modules, circuits, etc. may be performed by a single component, device, system, network, module, circuit, etc.

FIG. 2D depicts an illustrative embodiment of a method 250 in accordance with various aspects described herein. In some embodiments, one or more process blocks of FIG. 2D can be performed by the carrier aggregation control system 202, which may be implemented in a device included in or associated with a base station.

At 252, the method can include determining a quality of a communication path between a user equipment (UE) and a base station, resulting in a determined quality. For example, the carrier aggregation control system 202 can, similar to that described above with respect to the system 200 of FIG. 2A, perform one or more operations that include determining a quality of a communication path between a user equipment (UE) and a base station, resulting in a determined quality.

At 254, the method can include, based on the determined quality, controlling aggregation of one or more time division duplexing (TDD) carriers and one or more frequency division duplexing (FDD) carriers in an uplink (UL) such that either the one or more TDD carriers or the one or more FDD carriers are selected for a Primary cell (Pcell) for the UE. For example, the carrier aggregation control system 202 can, similar to that described above with respect to the system 200 of FIG. 2A, perform one or more operations that include, based on the determined quality, controlling aggregation of one or more time division duplexing (TDD) carriers and one or more frequency division duplexing (FDD) carriers in an uplink (UL) such that either the one or more TDD carriers or the one or more FDD carriers are selected for a Primary cell (Pcell) for the UE.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

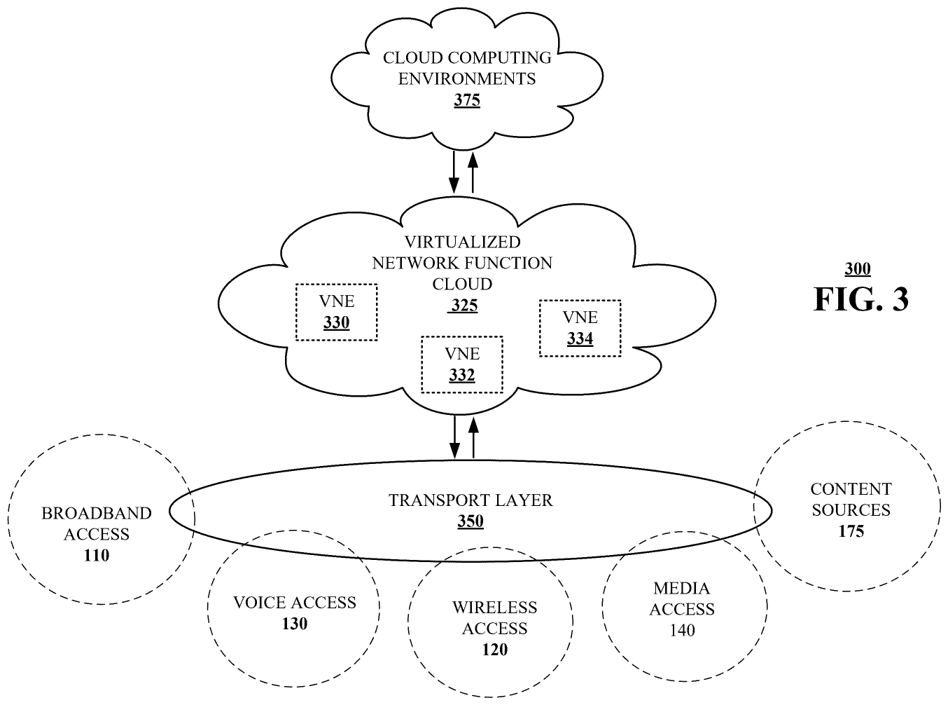

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and method 250 presented in FIGS. 1, 2A, and 2D. For example, virtualized communications network 300 can facilitate, in whole or in part, controlling of carrier aggregation for a UE such that TDD carrier(s) or FDD carrier(s) are selected as the dominant carrier(s) in the UL based on conditions relating to communications between the UE and a base station.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates.

The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

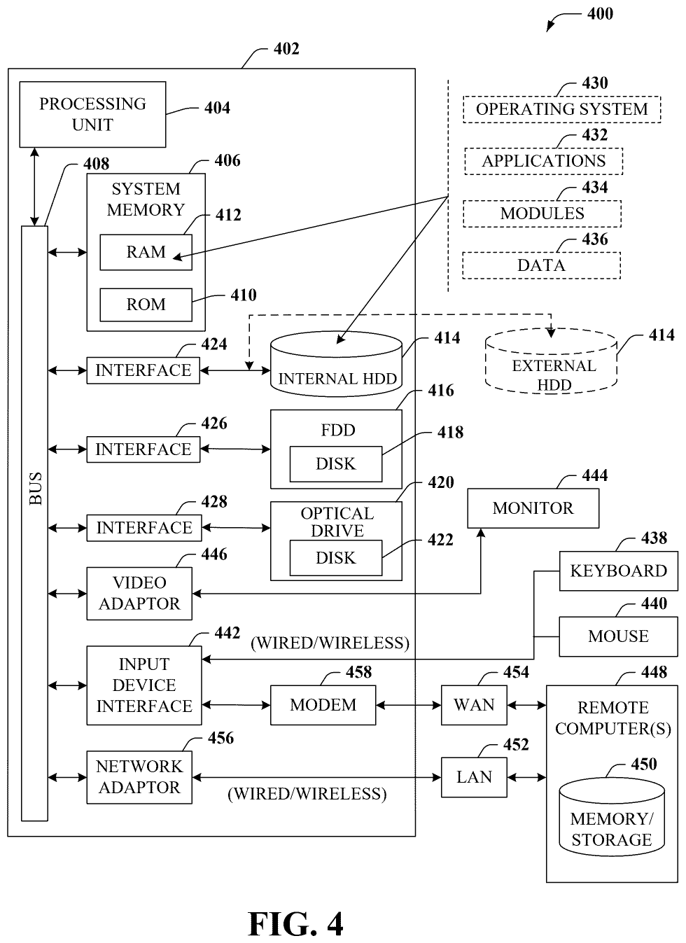

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, controlling of carrier aggregation for a UE such that TDD carrier(s) or FDD carrier(s) are selected as the dominant carrier(s) in the UL based on conditions relating to communications between the UE and a base station.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

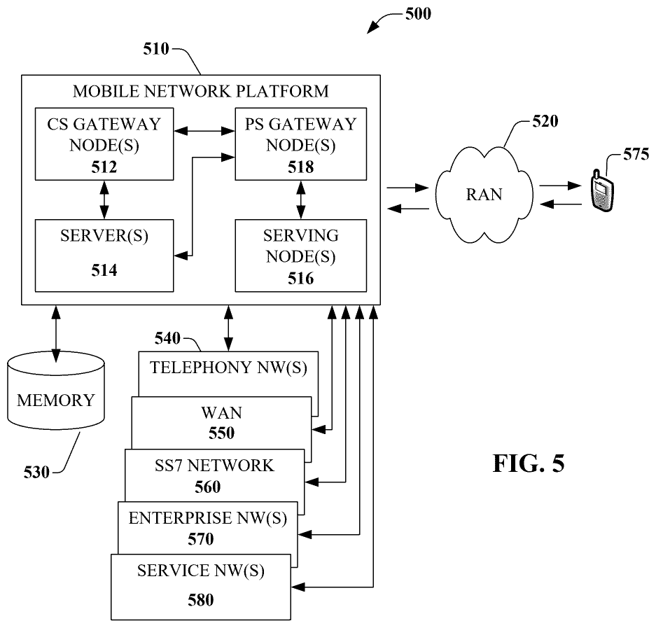

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, controlling of carrier aggregation for a UE such that TDD carrier(s) or FDD carrier(s) are selected as the dominant carrier(s) in the UL based on conditions relating to communications between the UE and a base station. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

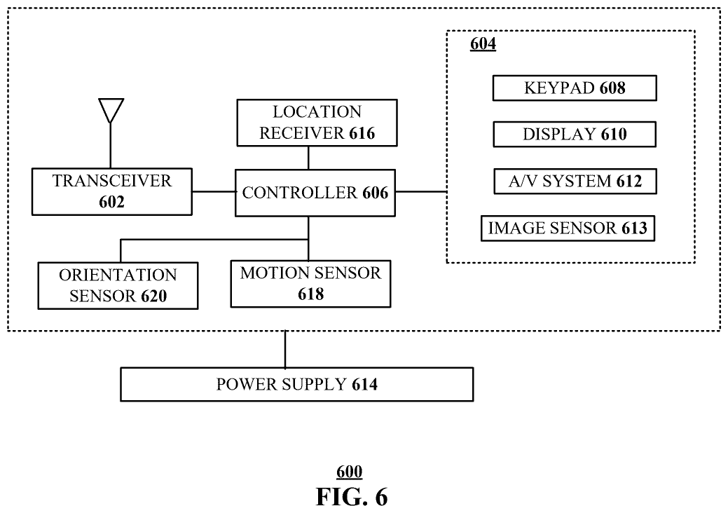

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, controlling of carrier aggregation for a UE such that TDD carrier(s) or FDD carrier(s) are selected as the dominant carrier(s) in the UL based on conditions relating to communications between the UE and a base station.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, X=(x1, x2, x3, x4, . . . , xn), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
determining a quality of a communication path between a user equipment (UE) and a base station, resulting in a determined quality; and
based on the determined quality, controlling aggregation of one or more time division duplexing (TDD) carriers and one or more frequency division duplexing (FDD) carriers in an uplink (UL) such that either the one or more TDD carriers or the one or more FDD carriers are selected for a Primary cell (Pcell) for the UE.

2. The device of claim 1, wherein the determining the quality involves an analysis of TDD downlink (DL) reference signal received power (RSRP), FDD DL RSRP, or both.

3. The device of claim 2, wherein the controlling the aggregation involves selecting the one or more TDD carriers for the Pcell based on the TDD DL RSRP being greater than or equal to a threshold or being greater than or equal to the FDD DL RSRP by more than a threshold amount.

4. The device of claim 3, wherein the determining the quality further involves an additional analysis of a TDD DL reference signal received quality (RSRQ), a TDD DL signal-to-interference-plus-noise ratio (SINR), UL transmit power headroom, or an UL SINR estimate for the one or more TDD carriers.

5. The device of claim 4, wherein the one or more TDD carriers are selected for the Pcell only if the additional analysis indicates that the TDD DL RSRQ, the TDD DL SINR, or the SINR estimate for the one or more TDD carriers is greater than or equal to a particular value.

6. The device of claim 2, wherein the controlling the aggregation involves selecting the one or more FDD carriers for the Pcell based on the FDD DL RSRP being greater than or equal to a threshold or being greater than or equal to the TDD DL RSRP by more than a threshold amount.

7. The device of claim 6, wherein the determining the quality further involves an additional analysis of an FDD DL RSRQ, an FDD DL SINR, or a SINR estimate for the one or more FDD carriers.

8. The device of claim 7, wherein the one or more FDD carriers are selected for the Pcell only if the additional analysis indicates that the FDD DL RSRQ, the FDD DL SINR, or the SINR estimate for the one or more FDD carriers is greater than or equal to a particular value.

9. The device of claim 1, wherein the controlling the aggregation involves selecting the one or more TDD carriers for the Pcell, and wherein the selecting causes the UE to allocate all or more than a threshold portion of transmit power resources for the one or more TDD carriers.

10. The device of claim 9, wherein the one or more FDD carriers remain aggregated and active or enabled despite the UE allocating all or more than the threshold portion of the transmit power resources for the one or more TDD carriers.

11. The device of claim 1, wherein the controlling the aggregation involves selecting the one or more FDD carriers for the Pcell, and wherein the selecting causes the UE to allocate all or more than a threshold portion of transmit power resources for the one or more FDD carriers.

12. The device of claim 11, wherein the one or more TDD carriers remain aggregated and active or enabled despite the UE allocating all or more than the threshold portion of the transmit power resources for the one or more FDD carriers.

13. The device of claim 1, wherein the determining the quality involves an analysis of throughput associated with the one or more TDD carriers, throughput associated with the one or more FDD carriers, or both.

14. The device of claim 13, wherein the controlling the aggregation involves selecting the one or more TDD carriers for the Pcell based on the throughput associated with the one or more TDD carriers being greater than or equal to a threshold or being greater than or equal to the throughput associated with the one or more FDD carriers by more than a threshold amount.

15. The device of claim 13, wherein the controlling the aggregation involves selecting the one or more FDD carriers for the Pcell based on the throughput associated with the one or more FDD carriers being greater than or equal to a threshold or being greater than or equal to the throughput associated with the one or more TDD carriers by more than a threshold amount.

16. The device of claim 1, wherein the determined quality approximates a position of the UE relative to the base station, and wherein the position ranges from a determined cell center to a determined cell edge.

17. The device of claim 1, wherein the one or more FDD carriers are in a lower frequency range than the one or more TDD carriers.

18. A non-transitory machine-readable medium, comprising executable instructions that, when executed by a processing system including a processor, facilitate performance of operations, the operations comprising:
analyzing conditions associated with communications between a user equipment (UE) and a base station; and
based on the analyzing, causing one or more time division duplexing (TDD) uplink (UL) carriers or one or more frequency division duplexing (FDD) UL carriers to be selected for a Primary cell (Pcell) for the UE.

19. The non-transitory machine-readable medium of claim 18, wherein, when the conditions indicate that the UE is located at or within a threshold distance from a cell center, the causing comprises causing the one or more TDD UL carriers to be selected for the Pcell, and wherein, when the conditions indicate that the UE is located at a cell edge or at greater than the threshold distance from the cell center, the causing comprises causing the one or more FDD UL carriers to be selected for the Pcell.

20. A method, comprising:
sending, by a processing system of a user equipment (UE) including a processor, one or more measurements associated with communications between the UE and a base station;
after the sending, receiving, by the processing system and from the base station, a command to use a selected carrier in an uplink (UL) for a Primary cell (Pcell), wherein the selected carrier comprises a time division duplexing (TDD) carrier or a frequency division duplexing (FDD) carrier; and
based on the command, causing, by the processing system, all or more than a threshold portion of transmit power resources to be utilized for the selected carrier.
